(19) United States
(12) Patent Application Publication
(10) Pub. No.: US 2026/0230748 A1
(43) Pub. Date: Aug. 6, 2026

(54) SOUND SOURCE LOCALIZING HEADWEAR AND FEEDBACK DEVICE

(71) Applicant: Toyota Motor Engineering & Manufacturing North America, Inc., Plano, TX (US)

(72) Inventors: Taehwa Lee, Ann Arbor, MI (US); Ziqi Yu, Ann Arbor, MI (US); Xiaopeng Li, Ann Arbor, MI (US); Hyung Suk Kwon, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/298,282

(22) Filed: Aug. 13, 2025

Related U.S. Application Data
(63) Continuation-in-part of application No. 19/042,392, filed on Jan. 31, 2025.
(63) Continuation-in-part of application No. 19/079,562, filed on Mar. 14, 2025.

(51) Int. Cl. H04R 1/40; G01B 17/00; G02B 27/01; H04R 3/00

(52) U.S. Cl. CPC H04R 1/406; G01B 17/00; G02B 27/0172; G02B 27/0176; H04R 3/005; G02B 2027/0138; G02B 2027/014; G02B 2027/0141; H04R 2201/401; H04R 2499/15

(57) ABSTRACT

Systems, methods, and other embodiments described herein relate to determining a location of a sound source and providing feedback of the location to a user. In one embodiment, a method includes determining, via a sound localization system disposed on a frame to be worn on a head of a user, an azimuth angle and an elevation angle of a sound source. The sound localization system includes 1) an array of transducers, 2) a feedback system, and 3) a capacitively coupled circuit per transducer pair. The method also includes generating, via the feedback system, feedback to indicate a location of the sound source relative to a center point of a transparent display surface of the frame.

### CROSS-REFERENCE TO RELATED APPLICATIONS

This application is a continuation-in-part of U.S. Non-Provisional application Ser. No. 19/042,392, filed on Jan. 31, 2025, and U.S. Non-Provisional application Ser. No. 19/079,562, filed on Mar. 14, 2025, which are herein incorporated by reference in their entirety.

### TECHNICAL FIELD

The subject matter described herein relates, in general, to sound source localization and, more particularly, to a wearable frame with a sound source localization system and feedback system for indicating the location of the sound source.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

The world we live in is saturated with a constant stream of stimuli, whether visual or auditory. For example, in urban areas, a user may be exposed to flashing screens and various sources of auditory stimulus such as infrastructure elements (e.g., beeping crosswalk signal), pedestrians, vehicles, construction equipment, street performers, and the like. Sensory stimulation may occur in other environments as well. For example, a worker in a factory may be exposed to various forms of auditory stimuli, such as different machinery and conversing colleagues.

While this stimulation may be exciting and enriching, it may overwhelm our senses and fragment our attention, which could lead to distraction, confusion, and/or anxiety. In such a scenario, staying focused and localizing relevant stimuli may become difficult. As a particular example, in some cases, the auditory stimulus is meant as a warning to people in the environment. An individual who is unable to localize the source of the warning signal may be unaware of the condition that warrants their attention, thus leading to a potentially hazardous situation.

### SUMMARY

In one embodiment, example systems and methods relate to a manner of identifying and indicating the location of a sound source in the surrounding environment of a user.

In one embodiment, a system for 1) identifying the location of a sound source and 2) indicating the location of the sound source to a user via a headworn frame is disclosed. The system includes a frame to be worn on a head of a user. The frame includes a transparent display surface. The system also includes a sound localization system disposed on the frame. The sound localization system includes 1) an array of transducers, 2) a feedback system, and 4) a capacitively coupled circuit per transducer pair. The system also includes a data acquisition system. The data acquisition system includes memory including machine-readable instructions that, when executed by a processor, cause the processor to 1) determine an azimuth angle and an elevation angle of a sound source and 2) generate, via the feedback system, feedback to indicate a location of the sound source relative to a center point of the transparent display surface.

In one embodiment, a non-transitory machine-readable medium for 1) identifying the location of a sound source and 2) indicating the location of the sound source to a user via a headworn frame and including instructions that, when executed by a processor, causes the processor to perform one or more functions is disclosed. The instructions include instructions to determine, via a sound localization system disposed on a frame to be worn on a head of a user, an azimuth angle and an elevation angle of a sound source. The sound localization system includes 1) an array of transducers, 2) a feedback system, and 3) a capacitively coupled circuit per transducer pair. The instructions also include instructions to generate, via the feedback system, feedback to indicate a location of the sound source relative to a center point of a transparent display surface of the frame.

In one embodiment, a method for 1) identifying the location of a sound source and 2) indicating the location of the sound source to a user via a headworn frame is disclosed. In an embodiment, the method includes determining, via a sound localization system disposed on a frame to be worn on a head of a user, an azimuth angle and an elevation angle of a sound source. The sound localization system includes 1) an array of transducers, 2) a feedback system, and 3) a capacitively coupled circuit per transducer pair. The method also includes generating, via the feedback system, feedback to indicate a location of the sound source relative to a center point of a transparent display surface of the frame.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a scenario where an acoustic camera utilizes one or more capacitively coupled circuits that can determine the source location of an acoustic wave.

FIG. 2 illustrates a system that incorporates the acoustic camera of FIG. 1 that can determine the source location of an acoustic wave.

FIGS. 3A and 3B illustrate examples of the capacitively coupled circuits that may be utilized with the acoustic camera of FIG. 1.

FIG. 4 illustrates a data acquisition system that may be utilized with the system of FIG. 2 to determine the source location of an acoustic wave.

FIG. 5 illustrates a method for determining the source location of an acoustic wave utilizing the acoustic camera of FIG. 1.

FIGS. 6A and 6B illustrate examples of voltages that may be output by the capacitively coupled circuits that may be utilized with the acoustic camera of FIG. 1.

FIGS. 7A and 7B illustrate a frame and sound localization system for identifying and indicating a sound source location.

FIG. 8 illustrates one embodiment of a data acquisition system that is associated with identifying and indicating a sound source location.

FIGS. 9A and 9B illustrate a frame and various feedback devices that increase feedback intensity based on the location of the sound source.

FIG. 10 illustrates a flowchart for one embodiment of a method that is associated with identifying and indicating a sound source location.

FIG. 11 illustrates a frame with an acoustic feedback system for identifying and indicating a sound source location.

FIG. 12 illustrates a frame with a haptic feedback system for identifying and indicating a sound source location.

FIG. 13 illustrates a frame with a visual feedback system for identifying and indicating a sound source location.

FIG. 14 illustrates a frame with a first type of projection system for identifying and indicating a sound source location.

FIG. 15 illustrates the frame with a second type of projection system for identifying and indicating a sound source location.

### DETAILED DESCRIPTION

Described herein are acoustic cameras and related systems and methods that utilize capacitively coupled circuits. Moreover, in one example, an acoustic camera includes a camera sensor and transducers disposed adjacent to the camera sensor. The transducers are configured to be connected to one or more capacitively coupled circuits. A data acquisition system utilizes information generated by the capacitively coupled circuits to determine an azimuth angle and an elevation angle of the source location of an acoustic wave with respect to the camera sensor. Using this information, the data acquisition device may then display on a display device the source location of the acoustic wave on an image captured by the camera sensor.

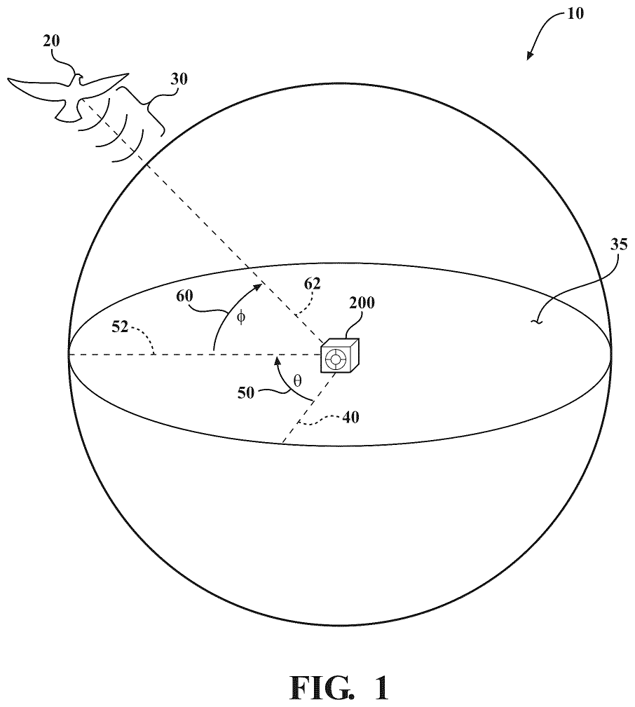

To better illustrate this concept, reference is made to FIG. 1, which illustrates an example scenario 10, which includes an acoustic camera 200 that includes an image sensor and transducers located adjacent to the camera sensor. A more detailed view of the acoustic camera 200 and the image sensors and transducers will be provided in the later figures and described in the paragraphs that follow. Here, also shown is an acoustic wave 30 that was produced by a sound source 20. In this example, the sound source 20 is in the form of an eagle that has produced the acoustic wave 30 by emitting an acoustic call.

As will be described in the paragraphs that follow, the acoustic camera 200 is capable of capturing images, including images that may include the sound source 20. In addition, the acoustic camera 200 has transducers that can detect and output information regarding the acoustic wave 30. Information output from the transducers will be provided to one or more capacitively coupled circuits that, in turn, provide information to a data acquisition device that can determine the azimuth angle 50 and the elevation angle 60 of the sound source 20 with respect to a camera sensor of the acoustic camera 200.

Moreover, the azimuth angle 50 is the angle between line 40, defined by the forward view of the camera sensor of the acoustic camera 200, and the line 52, which indicates the direction of the sound source 20 along the horizontal plane 35. The elevation angle 60 is the angle between line 52 and the line of sight 62 of the sound source 20, which is above the horizontal plane 35. Once the azimuth angle 50 and the elevation angle 60 are determined, the data acquisition device can display on a display device the image captured by the acoustic camera 200 that includes the sound source 20 and an indication of where the sound source is on the captured image.

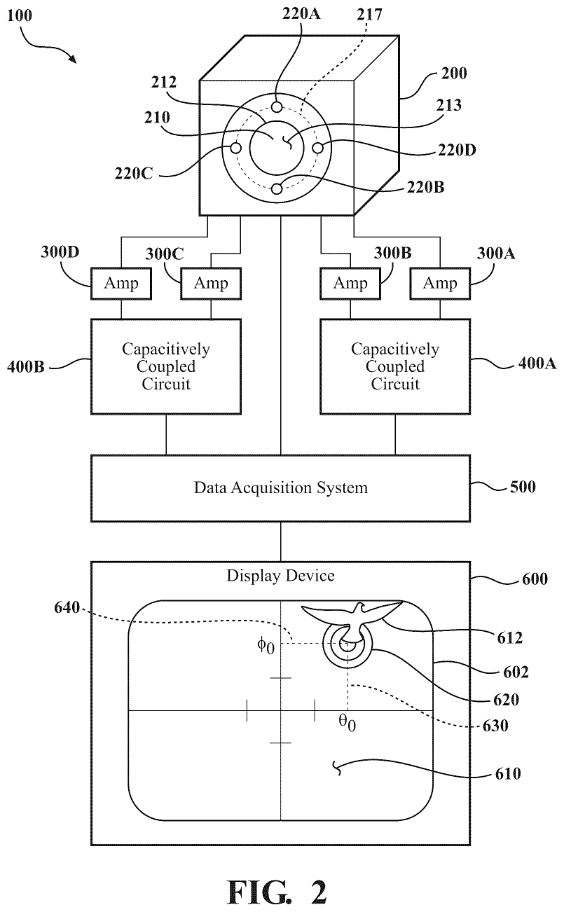

Referring to FIG. 2, illustrated is a more detailed view of a system that includes the acoustic camera 200, amplifiers 300A-300D, capacitively coupled circuits 400A and 400B, a data acquisition system 500, and a display device 600. In this example, the acoustic camera 200, as explained earlier, includes a camera sensor 210 capable of capturing images. The camera sensor 210 captures images by converting light into electronic signals to create the image. The camera sensor 210 can be any type of image sensor, such as a charge-coupled device (“CCD”) and/or a complementary metal-oxide-semiconductor (“CMOS”) sensor. Further, the camera sensor 210 can capture images across a variety of different spectrums, not just the visible spectrum. For example, the camera sensor 210 may also be able to capture infrared or ultraviolet images.

The camera sensor 210 may define a perimeter 212, which generally surrounds the camera sensor 210. In some cases, the perimeter 212 of the camera sensor 210 may be defined by a lens 213 or a protective structure for protecting the camera sensor 210 from damage. Located adjacent to the camera sensor 210 and/or the perimeter 212 may be transducers 220A-220D. The transducers 220A-220D may be disposed of along the perimeter 212 such that they are equally spaced apart from each other. When configured as such, the transducers 220A and 220B are generally located on opposing sides of the camera sensor 210 and oppose each other. In like manner, the transducers 220C and 220D are also generally located on opposing sides of the camera sensor 210 and oppose each other. As such, if a circle 217 is fit around the transducers 220A-220D, each of the transducers 220A-220D would be located approximately 90° apart from each other along the circle 217 with the transducers 220A and 220B being 180° apart from each other and the transducers 220C and 220D being 180° apart from each other.

As will be explained later, the transducers 220A and 220B generate signals that are used to determine the elevation angle 60, while the transducers 220C and 220D generate signals that are used to determine the azimuth angle 50. As such, the transducers 220A and 220B can be paired together to determine the elevation angle 60, while the transducers 220C and 220D can be paired together to determine the azimuth angle 50.

The transducers 220A-220D can take any one of a number of different forms. In one example, the transducers 220A-220D may be any device that converts mechanical and/or sound energy into electrical signals. Moreover, the transducers 220A-220D operate based on the principle of transduction, where one form of energy is transformed into another. As such, the transducers 220A-220D may be microphones that convert acoustic waves into electrical signals. In one example, the transducers 220A-220D may be micro-electro-mechanical system (“MEMS”) microphones. A MEMS microphone is a small, pressure-sensitive microphone created using semiconductor technology. It may include a diaphragm etched into a silicon wafer, which moves in response to sound waves. This movement creates an electrical signal that can be amplified and converted into digital data.

The signals outputted by the transducers 220A-220D may be amplified by amplifiers 300A-300D, respectively, to amplify the signals. Moreover, the amplifiers 300A-300D may boost low-level audio signals, such as those outputted by the transducers 220A-220D, to a higher level. The amplifiers 300A-300D may enhance the power of the audio signals outputted by the transducers 220A-220D without significantly altering their original quality.

The amplified signals from the amplifiers 300A and 300B are then provided to a capacitively coupled circuit 400A, while the amplified signals from the amplifiers 300C and 300D are provided to a capacitively coupled circuit 400B. Each of the capacitively coupled circuits 400A and 400B, as will be explained later, includes two different circuits (sometimes referred to as different stages) that are connected to each other utilizing a capacitor. This type of coupling isolates the different circuits and prevents direct current (“DC”) bias.

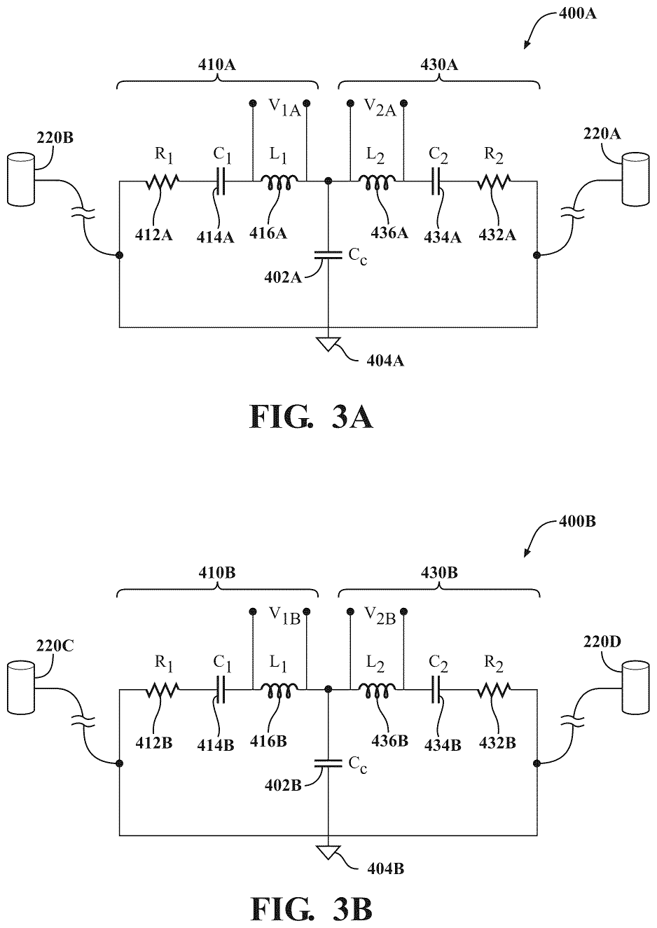

FIGS. 3A and 3B illustrate examples of the capacitively coupled circuit 400A. Here, the capacitively coupled circuit 400A includes a first circuit 410A and a second circuit 430A that are connected to each other via a connecting capacitor 402A (C_{C}). The first circuit 410A and the second circuit 430A may be substantially equal (i.e., within 10%) to each other and include the same components having the same parameters (i.e., such as the same (within 10%) inductance, resistance, and capacitance).

Moreover, the first circuit 410A may be an inductor-resistor-capacitor circuit that includes a resistor 412A (R₁), a capacitor 414A (C₁), and an inductor 416A (L₁) that are connected in series, wherein the inductor 416A (L₁) is connected to the connecting capacitor 402A (C_{C}), and the resistor 412A (R₁) is connected to ground 404A. Similarly, the second circuit 430A may be an inductor-resistor-capacitor circuit that includes a resistor 432A (R₂), a capacitor 434A (C₂), and an inductor 436A (L₂) that are connected in series, wherein the inductor 436A (L₂) is connected to the connecting capacitor 402A (C_{C}), and the resistor 432A (R₂) is connected to ground 404A. The resistance of the resistors 412A (R₁) and 432A (R₂), the capacitance of the capacitors 414A (C₁) and 434A (C₂), and the inductance of the inductors 416A and 436A (L₂) may be substantially equal to one another. As such, the resistors 412A (R₁) and 432A (R₂) may have the same resistance, the capacitors 414A (C₁) and 434A (C₂) may have the same capacitance, and the inductors 416A and 436A may have the same inductance. Generally, the capacitance of the connecting capacitor 402A (C_{C}) may be greater than that of the capacitors 414A (C₁) and/or 434A (C₂). In one example, the capacitance of the connecting capacitor 402A (C_{C}) may be approximately five times greater than the capacitance of the capacitors 414A (C₁) and/or 434A (C₂).

The transducer 220A, via the amplifier 300A, is connected between the second circuit 430A and the ground 404A. In like manner, the transducer 220B is connected between the first circuit 410A and the ground 404A. When the acoustic wave 30 is detected by the transducers 220A and 220B, voltages V_{1A} and V_{2A} are generated across the inductors 416A and 436A, respectively. As will be explained in the paragraphs that follow, the voltages V_{1A} and V_{2A} will be utilized by the data acquisition system 500 to determine the elevation angle 60 of the sound source 20 with respect to the camera sensor 210 of the acoustic camera 200.

FIG. 3B illustrates one example of the capacitively coupled circuit 400B, which is substantially similar to the capacitively coupled circuit 400A, except as noted otherwise. Here, the capacitively coupled circuit 400B includes a first circuit 410B and a second circuit 430B, which are connected to each other via a connecting capacitor 402B (C_{C}). The first circuit 410B and the second circuit 430B may be substantially equal (i.e., within 10%) to each other and include the same components having the same parameters (i.e., such as the same (within 10%) inductance, resistance, and capacitance).

Moreover, the first circuit 410B may be an inductor-resistor-capacitor circuit that includes a resistor 412B (R₁), a capacitor 414B (C₁), and an inductor 416B (L₁) that are connected in series, wherein the inductor 416B (L₁) is connected to the connecting capacitor 402B (C_{C}), and the resistor 412B (R₁) is connected to ground 404B. Similarly, the second circuit 430B may be an inductor-resistor-capacitor circuit that includes a resistor 432B (R₂), a capacitor 434B (C₂), and an inductor 436B (L₂) that are connected in series, wherein the inductor 436B (L₂) is connected to the connecting capacitor 402B (C_{C}), and the resistor 432B (R₂) is connected to ground 404B. The resistance of the resistors 412B (R₁) and 432B (R₂), the capacitance of the capacitors 414B (C₁) and 434B (C₂), and the inductance of the inductors 416B and 436B (L₂) may be substantially equal to one another. As such, the resistors 412B (R₁) and 432B (R₂) may have the same resistance, the capacitors 414B (C₁) and 434B (C₂) may have the same capacitance, and the inductors 416B and 436B may have the same inductance. Generally, the capacitance of the connecting capacitor 402B (C_{C}) may be greater than that of the capacitors 414B (C₁) and/or 434B (C₂). In one example, the capacitance of the connecting capacitor 402B (C_{C}) may be approximately five times greater than the capacitance of the capacitors 414B (C₁) and/or 434B (C₂).

As mentioned before, the capacitively coupled circuits 400A and 400B may be substantially similar to each other and, therefore, may utilize similar electrical components having similar specifications. As such, the resistance of the resistors 412A, 412B, 432A, and 432B, the capacitance of the capacitors 414A, 414B, 434A, and 434B, and the inductance of the inductors 416A, 416B, 436A, and 436B may be substantially equal to one another. Further still, the capacitance of the connecting capacitors 402A and 402B may also be substantially similar.

The transducer 220C, via the amplifier 300C, is connected between the first circuit 410B and the ground 404B. In like manner, the transducer 220D is connected between the second circuit 430B and the ground 404B. When the acoustic wave 30 is detected by the transducers 220C and 220D, voltages V_{1B} and V_{2B} are generated across the inductors 416B and 436B, respectively. As will be explained in the paragraphs that follow, the voltages V_{1B} and V_{2B} will be utilized by the data acquisition system 500 to determine the azimuth angle 50 of the sound source 20 with respect to the camera sensor 210 of the acoustic camera 200.

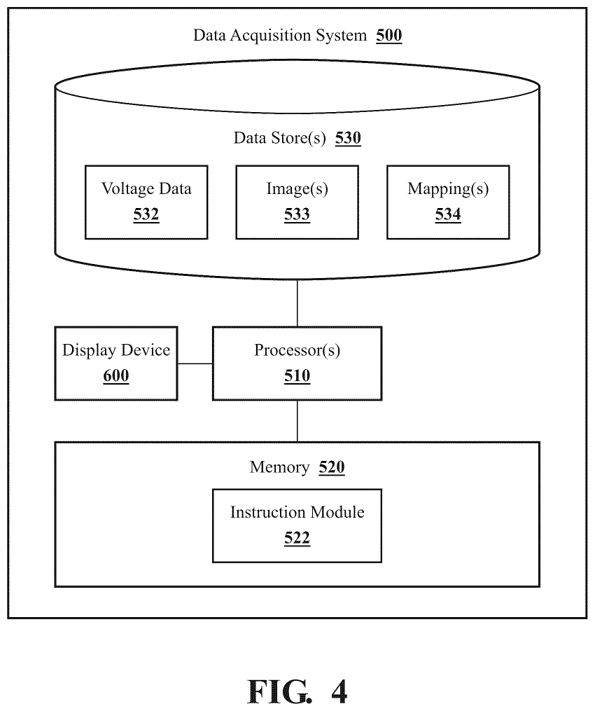

FIG. 4 illustrates a more detailed view of the data acquisition system 500 that will be utilized to determine the location of the sound source 20 of the acoustic wave 30 of FIG. 1 with respect to the camera sensor 210 of the acoustic camera 200. It should be understood that the data acquisition system 500 is just one example that the data acquisition system 500 may take. As such, the data acquisition system 500 may have more, fewer, or even different components than those illustrated in FIG. 4.

Here, in this example, the data acquisition system 500 includes one or more processor(s) 510. Accordingly, the processor(s) 510 may be a part of the data acquisition system 500, or the data acquisition system 500 may access the processor(s) 510 through a data bus or another communication path. In one or more embodiments, the processor(s) 510 is an application-specific integrated circuit that is configured to implement functions associated with an instruction module 522. In general, the processor(s) 510 is an electronic processor, such as a microprocessor, which is capable of performing various functions as described herein.

The data acquisition system 500 may also include a display device 600 that is in communication with the processor(s) 510. The display device 600 may be incorporated within the data acquisition system 500 or may be external to the data acquisition system 500, as shown in FIG. 4. As best shown in FIG. 2, the display device 600 can include a display area 602 for displaying an image 610 captured by the camera sensor 210 of the acoustic camera 200. As will be explained in greater detail later, in addition to displaying the image 610, the display device 600 may also display a representation 612 of the sound source, such as the sound source 20 of FIG. 1, which was previously stated to be an eagle, and an icon 620 representing the source of the sound. In this case, the icon 620 is placed over the representation 612 of the eagle, which produced the sound. The display device 600 may also display the azimuth angle 630 and/or the elevation angle 640 in the display area 602 as well.

Returning to FIG. 4, the data acquisition system 500 includes a memory 520 that stores instruction module 522. The memory 520 may be a random-access memory (RAM), read-only memory (ROM), a hard disk drive, a flash memory, or other suitable memory for storing the instruction module 522. The instruction module 522 is, for example, computer-readable instructions that, when executed by the processor(s) 510, cause the processor(s) 510 to perform the various functions disclosed herein.

Furthermore, in one example, the data acquisition system 500 includes a data store(s) 530. The data store(s) 530 is, in one embodiment, an electronic data structure such as a database that is stored in the memory 520 or another memory and that is configured with routines that can be executed by the processor(s) 510 for analyzing stored data, providing stored data, organizing stored data, and so on. Thus, in one embodiment, the data store(s) 530 stores data used by the instruction module 522 in executing various functions.

In this example, the data store(s) 530 may include voltage data 532 collected from the capacitively coupled circuits 400A and 400B. More specifically, this voltage data 532 includes V_{1A}, V_{2A}, V_{1B}, and V_{2B}.

Moreover, when the transducers 220A and 220B sense the acoustic wave 30, a signal will be generated by the transducers 220A and 220B, which is amplified by the amplifiers 300A and 300B. This then results in the voltages V_{1A} and V_{2A} being generated across the inductors 416A (L₁) and 436A (L₂), respectively. The voltages V_{1A} and V_{2A} are then saved as corresponding pairs in the voltage data 532.

In like manner, when the transducers 220C and 220D sense the acoustic wave 30, a signal will be generated by the transducers 220C and 220D, which is amplified by the amplifiers 300C and 300D. This then results in the voltages V_{1B} and V_{2B} being generated across the inductors 416B (L₁) and 436B (L₂), respectively. The voltages V_{1B} and V_{2B} are then saved as corresponding pairs in the voltage data 532.

The mapping(s) 534 may be in the form of a reference table that references (1) a particular ratio of a corresponding pair of voltages V_{1A} and V_{2A} to a particular angle, which indicates the elevation angle 60 of the sound source 20 with respect to the camera sensor 210 of the acoustic camera 200 and (2) a particular ratio of a corresponding pair of voltages V_{1B} and V_{2B} to a particular angle, which indicates the azimuth angle 50 of the sound source 20 with respect to the acoustic camera 200. As such, by using the mapping(s) 534 and the voltage data 532, the azimuth angle 50 and the elevation angle 60 of the sound source 20 with respect to the camera sensor 210 of the acoustic camera 200 can be determined. Thereafter, the azimuth angle 50 and the elevation angle 60 can be utilized to display the icon 620 on the display device 600, indicating the source of the acoustic wave 30.

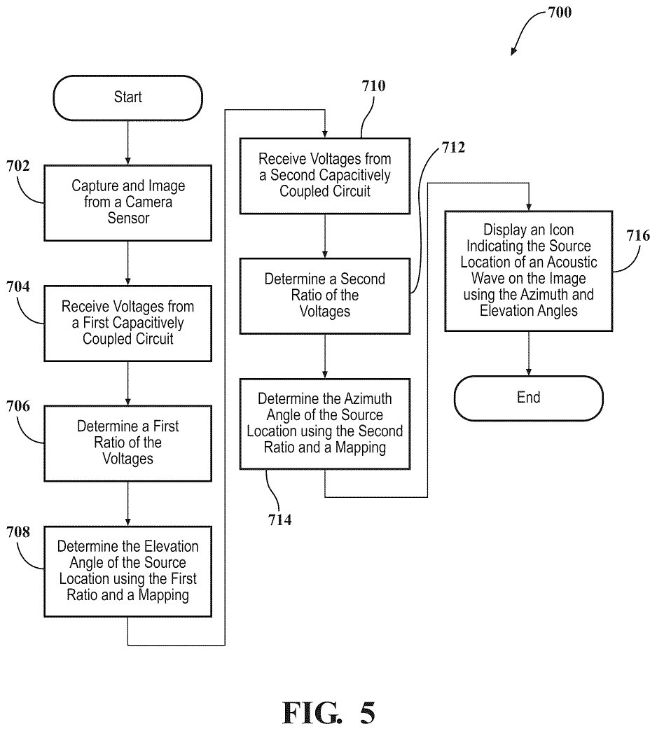

The instruction module 522 contains instructions that cause the processor(s) 510 to perform any of the methodologies described herein. With reference to FIG. 5, illustrated is a method 700 for determining the direction of the acoustic wave 30 using a capacitively coupled circuit. The method 700 will be described from the viewpoint of the system 100 in FIG. 2. However, it should be understood that this is just one example of implementing the method 700. While the method 700 is discussed in combination with the system 100, it should be appreciated that the method 700 is not limited to being implemented within the system 100 but is instead one example of a system that may implement the method 700. As such, the method 700 may be embodied within the instruction module 522 as processor-executable instructions that, when executed by the processor(s) 510, cause the processor(s) 510 to perform the method 700.

Moreover, in step 702, the instruction module 522 includes instructions that, when executed by the processor(s) 510, cause the processor(s) 510 to capture an image using the camera sensor 210 of the acoustic camera 200. The image may be stored within the data acquisition system 500 as the image(s) 533.

In step 704, the instruction module 522 includes instructions that, when executed by the processor(s) 510, cause the processor(s) 510 to receive a voltage (V_{1A}) and a voltage (V_{2A}) from the capacitively coupled circuit 400A. Alternatively, instead of receiving the voltage (V_{1A}) and the voltage (V_{2A}) directly from the capacitively coupled circuit 400A, the voltage (V_{1A}) and the voltage (V_{2A}) may have been previously stored in the data store(s) 530 as the voltage data 532.

As mentioned before, the voltage (V_{1A}) may be the voltage across the inductor 416A of the first circuit 410A, while the voltage (V_{2A}) may be the voltage across the inductor 436A of the second circuit 430A. Generally, the voltage (V_{1A}) and the voltage (V_{2A}) may be corresponding pairs of voltages measured at or near the same time as the image captured in step 702 was performed. As such, the voltage (V_{1A}) and the voltage (V_{2A}) are the voltages generated by the capacitively coupled circuit 400A when the acoustic wave 30 is sensed by the transducers 220A and 220B. As mentioned before, the voltage (V_{1A}) and the voltage (V_{2A}) may be stored as pairs as the voltage data 532 in the data store(s) 530.

In step 706, the instruction module 522 includes instructions that, when executed by the processor(s) 510, cause the processor(s) 510 to determine a ratio between the voltage (V_{1A}) and the voltage (V_{2A}). In one example, this may be determined by simply dividing the voltage (V_{1A}) by the voltage (V_{2A}) or vice versa.

In step 708, the instruction module 522 includes instructions that, when executed by the processor(s) 510, cause the processor(s) 510 to determine the elevation angle 60. In one example, as mentioned before, the mapping(s) 534 may be a reference table or lookup table that can be used to reference a particular ratio to the elevation angle 60 of the sound source 20 of the acoustic wave 30 with respect to the camera sensor 210 of the acoustic camera 200.

In step 710, the instruction module 522 includes instructions that, when executed by the processor(s) 510, cause the processor(s) 510 to receive a voltage (V_{1B}) and a voltage (V_{2B}) from the capacitively coupled circuit 400B. Alternatively, instead of receiving the voltage (V_{1B}) and the voltage (V_{2B}) directly from the capacitively coupled circuit 400B, the voltage (V_{1B}) and the voltage (V_{2B}) may have been previously stored in the data store(s) 530 as the voltage data 532.

As mentioned before, the voltage (V_{1B}) may be the voltage across the inductor 416B of the first circuit 410B, while the voltage (V_{2B}) may be the voltage across the inductor 436B of the second circuit 430B. Generally, the voltage (V_{1B}) and the voltage (V_{2B}) may be corresponding pairs of voltages measured at or near the same time as the image captured in step 702 was performed. As such, the voltage (V_{1B}) and the voltage (V_{2B}) are the voltages generated by the capacitively coupled circuit 400B when the acoustic wave 30 is sensed by the transducers 220C and 220D. As mentioned before, the voltage (V_{1B}) and the voltage (V_{2B}) may be stored as pairs as the voltage data 532 in the data store(s) 530.

In step 712, the instruction module 522 includes instructions that, when executed by the processor(s) 510, cause the processor(s) 510 to determine a ratio between the voltage (V_{1A}) and the voltage (V_{2A}). In one example, this may be determined by simply dividing the voltage (V_{1A}) by the voltage (V_{2A}) or vice versa.

In step 714, the instruction module 522 includes instructions that, when executed by the processor(s) 510, cause the processor(s) 510 to determine the azimuth angle 50. In one example, as mentioned before, the mapping(s) 534 may be a reference table or lookup table that can be used to reference a particular ratio to the azimuth angle 50 of the sound source 20 of the acoustic wave 30 with respect to the camera sensor 210 of the acoustic camera 200.

In this example, the method 700 first determined the elevation angle 60 (steps 704-708) before determining the azimuth angle 50 (steps 710-714). However, it should be understood that the method 700 may determine the azimuth angle 50 before determining the elevation angle 60. Further still, it may be possible that the method 700 may be able to determine the azimuth angle 50 and the elevation angle 60 concurrently.

In step 716, the instruction module 522 includes instructions that, when executed by the processor(s) 510, cause the processor(s) 510 to display the icon 620 in the display area 602 of the display device 600, such that the icon 620 indicates the location of the sound source 20 that produces the acoustic wave 30. This is accomplished by utilizing the azimuth angle 50 and the elevation angle 60, which generally indicates the direction of the sound source 20 that produces the acoustic wave 30 with respect to the camera sensor 210 of the acoustic camera 200. As best shown in FIG. 2, the icon 620 may be overlaid on a displayed image 610 of the image captured by the camera sensor 210 of the acoustic camera 200 at step 702. As such, the icon 620 can indicate the location within the displayed image 610 of the sound source 20 of the acoustic wave 30.

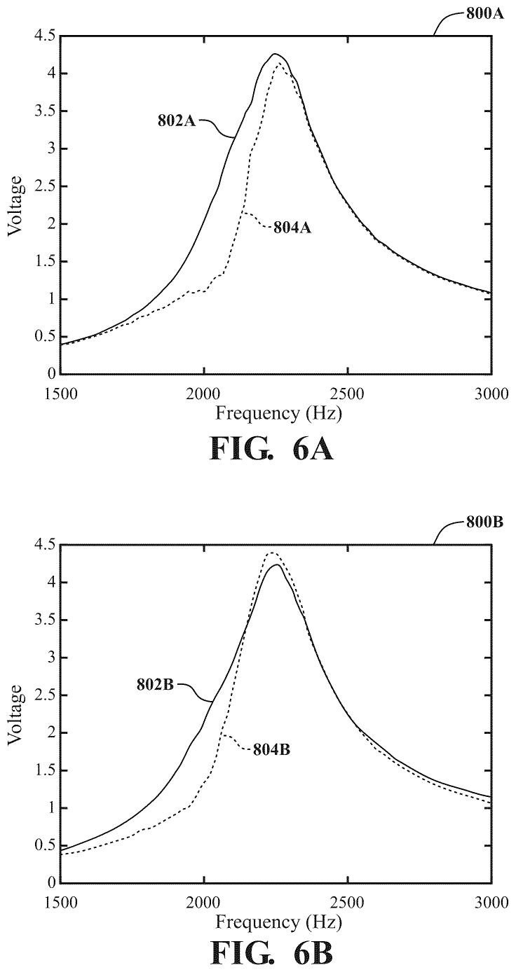

To better understand how a comparison (e.g., the ratio) of the voltage (V_{1A}) and the voltage (V_{2A}) is utilized to determine the elevation angle 60, reference is made to FIG. 6A. Moreover, FIG. 6A illustrates a chart 800A showing the value 802A of the voltage (V_{1A}) and the value 804A of the voltage (V_{2A}) across a frequency range of 1500-3000 Hz at a known angle. Here, the mapping(s) 534 essentially provides a numerical value regarding the elevation angle 60 with the ratios of the voltage (V_{1A}) and the voltage (V_{2A}) across a range of frequencies. As such, when one knows the ratio between the voltage (V_{1A}) and the voltage (V_{2A}), the mapping(s) 534 can be utilized to determine the elevation angle 60.

Similarly, FIG. 6B illustrates a chart 800B showing the value 802B of the voltage (V_{1B}) and the value 804B of the voltage (V_{2B}) across a frequency range of 1500-3000 Hz at a known angle. Like before, the mapping(s) 534 essentially provides a numerical value regarding the azimuth angle 50 with the ratios of the voltage (V_{1B}) and the voltage (V_{2B}) across a range of frequencies. As such, when one knows the ratio between the voltage (V_{1A}) and the voltage (V_{2A}), the mapping(s) 534 can be utilized to determine the azimuth angle 50.

As previously described, acoustic signals may serve to notify an individual of circumstances that warrant their attention. For example, an ambulance siren may induce a pedestrian or motorist to yield to an ambulance responding to an emergency. As another example, a person might shout to grab someone's attention and convey a message. However, it may be that some individuals are physically incapable or have a limited capability to identify the source of an acoustic signal. For example, a user may be hard of hearing. As another example, the acoustic signal (e.g., vehicle siren or shouting individual) may be in a noisy environment where the acoustic signal is muddled, mixed, or otherwise drowned out in a cacophony of other sounds. While specific reference is made to particular circumstances in which an audible notification or message is to be communicated between two parties, it would not take much time and effort to identify a vast number of circumstances where successful identification of a party/object intending to communicate with an individual would lead to improved communication. As described above, any of these situations may at least lead to miscommunication, and in some cases, may potentially result in a dangerous situation if the message, notification, or other acoustic signal is not received or acknowledged.

Accordingly, the present system describes sound localization and related systems that 1) identify the location of a sound source and 2) indicate the location to a user of a head-worn device. As described above, the sound localization system includes transducers that are arranged in a particular pattern with space between each transducer. The transducers are configured to be connected to one or more capacitively coupled circuits. A data acquisition system utilizes information generated by the capacitively coupled circuits to determine an azimuth angle and an elevation angle of a sound source with respect to a centroid of the transducer array. Using this information, a feedback system may generate feedback (e.g., acoustic, haptic, or visual) that may guide the gaze of the user toward the sound source.

While some systems may determine an acoustic incident angle, these systems may require a substantial distance between the multiple transducers (e.g., microphones). The increased distance between the transducers necessitates a larger framework, leading to systems that are often bulky and complex. As a result, these systems may be cumbersome to deploy, limiting their practicality in applications that demand compact, portable, or seamlessly integrated solutions. Moreover, such systems may not provide for an indication of the location of the sound source, such that the user/wearer of a head-worn frame (e.g., eyeglasses) may be able to locate the sound source within their field of view.

This sound localization system is integrated onto a head-worn frame, such as eyeglasses, with a transparent display surface. Once the azimuth and elevation location of the sound source have been identified, the data acquisition system operates a feedback device to generate feedback that 1) indicates the location of the sound source to the wearer and/or 2) guides the gaze of the wearer to the sound source. For example, the feedback system may include spaced feedback devices that may be selectively activated based on the location of the sound source. For example, for a sound source up and to the left of the center point of an eyeglass lens, top and left-mounted speakers on the frame may be activated to indicate to the wearer the location of the sound source.

As another example, the intensity of the feedback may be increased based on the distance of the sound source from the center of the transparent display surface. In this example, the feedback intensity may be increased as the sound source approaches the center of the transparent display surface. For example, as a user moves their head, the position of the sound source within the field of view of the user (e.g., through the transparent display surface) may change. When the sound source aligns with the center of the field of view, the volume of the audio feedback, vibration of the haptic feedback, or brightness of the visual feedback may be at a maximum level. Accordingly, the wearer may, through head movement, identify the location of the sound source when a maximum level of feedback is generated.

In another example, the feedback system may be an on-surface projection system. That is, the feedback system may include a lighting element such as a light-emitting diode (LED) or low-intensity laser pointer. Once the location of the sound source is identified, the data acquisition system may operate motors of the projection system to indicate the precise location of the sound source via an emanated light beam on the transparent display surface.

These feedback systems, including auditory cues, haptic vibration, visual lighting indicators, and on-surface light projections, may enhance situational awareness, especially in environments where visibility is limited or obstructed. The compact integration of sensing, processing, and notification systems within wearable glasses offers a hands-free, user-friendly solution for spatial audio perception.

In this way, the disclosed systems, methods, and other embodiments improve spatial awareness by not only identifying the location of a sound source, but generating feedback (e.g., auditory, haptic, or visual cues and on-surface projects) that indicate to the wearer the relative location of the sound source. All this is done on a system small enough to fit onto the frame of a head-worn device such as eyeglasses.

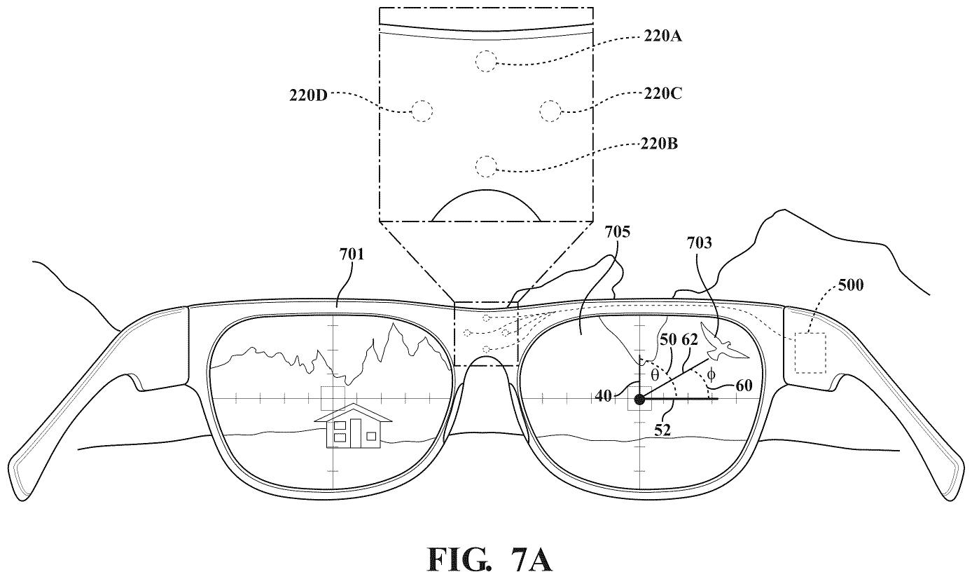

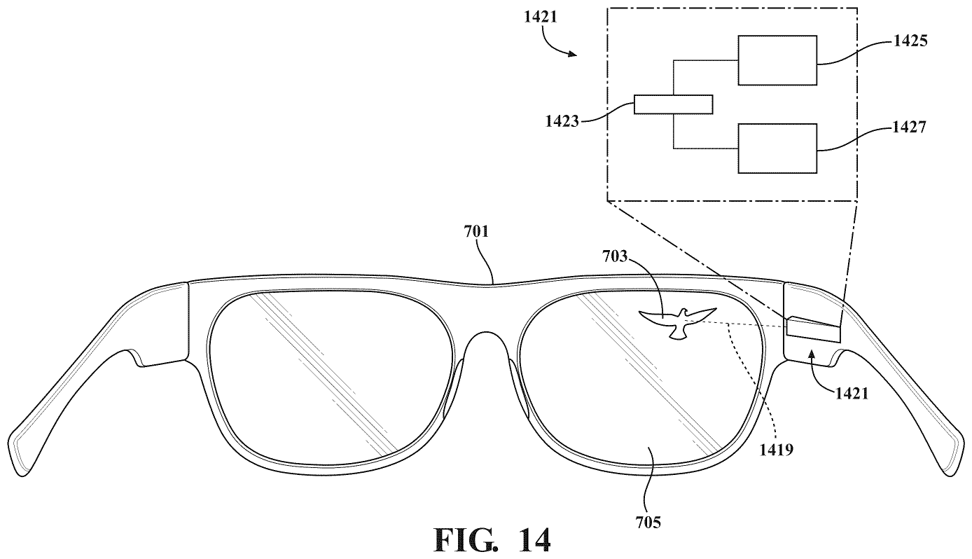

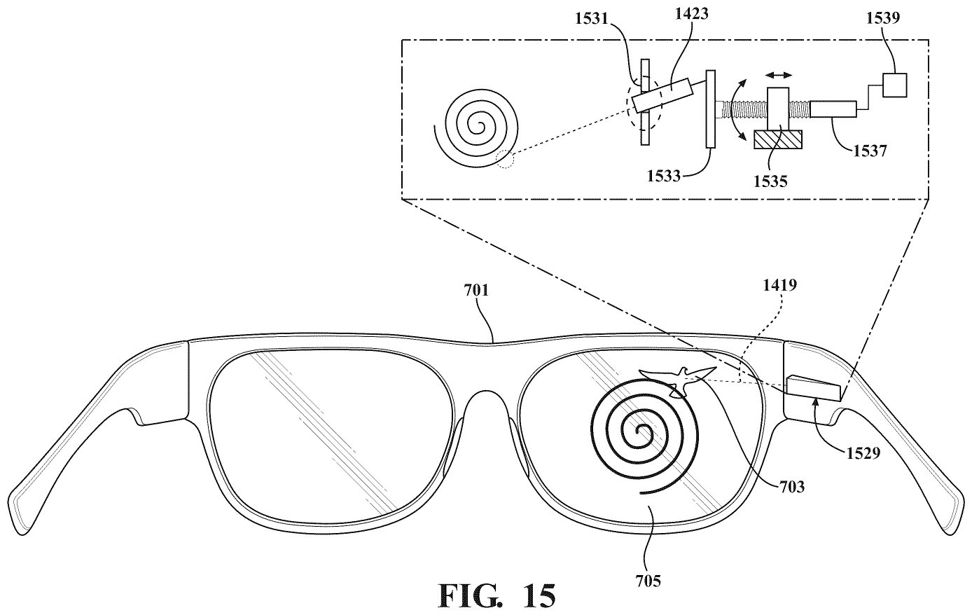

Turning now to the figures, FIGS. 7A and 7B illustrate a frame 701 and a sound localization system for identifying and indicating the location of a sound source 703. Specifically, FIG. 7A depicts the frame 701 from a rear, or user-facing side, while FIG. 7B depicts the frame 701 from a front, or environment-facing side. As described above, the sound localization system and accompanying components may be integrated into a frame 701, which is to be worn on the head of a user. In one specific example, such as that depicted in FIGS. 7A and 7B, the frame 701 is an eyeglasses frame with temples or arms that extend over the ears to hold the eyeglasses in place. The frame 701 may also include rims that hold the lenses, or transparent display surface(s) 705, in place. Through the transparent display surface(s) 705, a user may view the surrounding environment. In some examples, such as those depicted in FIGS. 14 and 15, an on-surface projection indicating the location of the sound source 703 may be presented on these transparent display surface(s) 705.

The system also includes a sound localization system that includes 1) an array of transducers 220A-D, 2) a feedback system, and 3) a capacitively coupled circuit per transducer pair. Note that in this example, the sound localization system may not include the camera sensor 210 described above. However, in other examples, such as those described above, the sound localization system may include a camera sensor 210, in which case the system may be referred to as an acoustic camera 200. When the system includes a camera sensor 210 disposed on the frame 701, the transducers 220A, 220B, 220C, and 220D of the array may be adjacent to and surrounding the camera sensor 210 as described above and as depicted in FIG. 2. That is, the transducers 220A, 220B, 220C, and 220D may be equally spaced apart from one another along a perimeter that surrounds the camera sensor 210. Transducers of a first pair (e.g., a first transducer 220A and a third transducer 220C) may be 180° away from each other around the perimeter, while transducers of a second pair (e.g., a second transducer 220B and a fourth transducer 220D) may be 180° away from each other around the perimeter. Note that in FIG. 7A, the transducers 220A, 220B, 220C, and 220D are depicted in a dashed line to indicate their position on the front side of the frame 701. By comparison, in FIG. 7B, the transducers 220A, 220B, 220C, and 220D are depicted in solid lines.

As described above, each transducer pair may be coupled to a respective capacitively coupled circuit 400A and 400B, with specific transducers 220A, 220B, 220C, and 220D being coupled to respective first circuits 410A and 410B and second circuits 430A and 430B as depicted in FIGS. 3A and 3B. That is, the sound localization system may include a capacitively coupled circuit per transducer pair.

As described above, via the transducers 220A, 220B, 220C, and 220D and the respective capacitively coupled circuits 400A and 400B, the data acquisition system 500, which is also integrated onto the frame 701, the sound localization system may determine the azimuth angle 50 and the elevation angle 60 of the sound source 703 with respect to a centroid of the sound localization system (e.g., with respect to a camera sensor 210 of the acoustic camera 200). Note that while FIGS. 7A and 7B depict particular arrangements of the transducers 220A, 220B, 220C, and 220D; the transducers 220A, 220B, 220C, and 220D may be arranged in different patterns and/or at different locations on the frame 701.

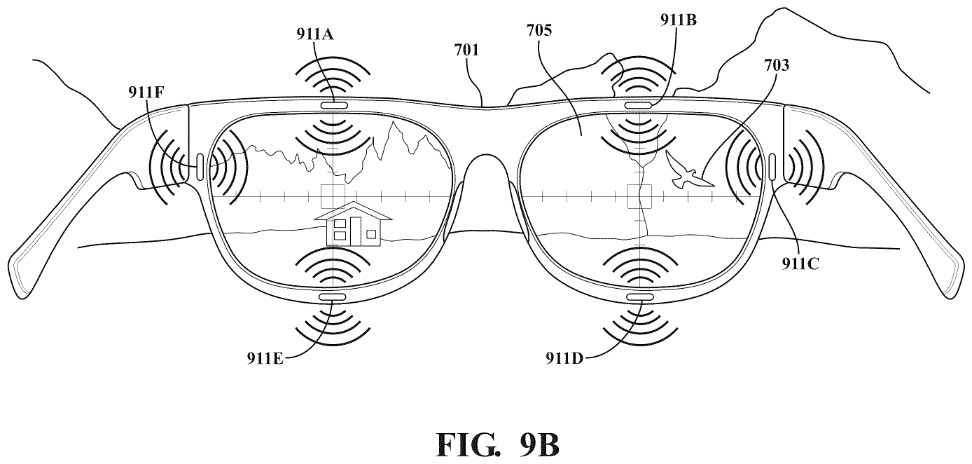

Once the azimuth angle 50 and the elevation angle 60 are determined, the data acquisition system 500 can generate, via the feedback system, feedback to indicate a location of the sound source 703 relative to a center point of the transparent display surface 705. The feedback system may take a variety of forms, examples of which are depicted in FIGS. 11-15 below.

To calculate the azimuth angle 50 and the elevation angle 60, the system may include a data acquisition system 500, which is similarly integrated onto the frame 701. Specifically, the data acquisition system 500 includes instructions that cause the processor 510 to determine an azimuth angle 50 and an elevation angle 60 of a sound source 703. The data acquisition system 500 also includes instructions that cause the processor 510 to generate, via the feedback system, feedback to indicate a location of the sound source 703 relative to a center point of the transparent display surface 705. This may include converting the azimuth angle 50 and the elevation angle 60 from a reference point of the sound localization system (e.g., transducer array with or without the camera sensor 210) to the transparent display surface 705. In an example, in addition to those components described above, the system may include a battery to power the system components.

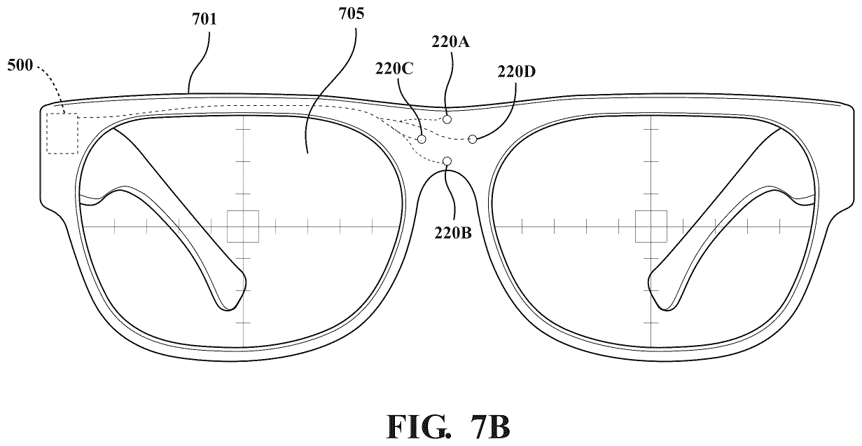

FIG. 8 illustrates the data acquisition system 500 for identifying and indicating the location of a sound source 703. As described above, the data acquisition system 500 may include one or more processor(s) 510, a memory 520 that stores an instruction module 522, and a data store(s) 530. Also as described above, the data store(s) 530 may include voltage data 532 collected from the capacitively coupled circuits 400A and 400B. More specifically, this voltage data 532 includes V_{1A}, V_{2A}, V_{1B}, and V_{2B}.

Still further, the data store(s) 530 may include mapping(s) 534 that map (1) a particular ratio of a corresponding pair of voltages V_{1A} and V_{2A} to a particular angle, which indicates the elevation angle 60 of the sound source 703 with respect to the centroid of the transducer array (e.g., the camera sensor 210 of the acoustic camera 200) and (2) a particular ratio of a corresponding pair of voltages V_{1B} and V_{2B} to a particular angle, which indicates the azimuth angle 50 of the sound source 703 with respect to the centroid of the transducer array (e.g., the camera sensor 210 of the acoustic camera 200). As such, by using the mapping(s) 534 and the voltage data 532, the azimuth angle 50 and the elevation angle 60 of the sound source 20 with respect to the camera sensor 210 of the acoustic camera 200 can be determined.

In an example, the mapping(s) 534 may also map (1) a particular azimuth angle 50 of the sound source 703 to a particular setting of the feedback system 809 and (2) a particular elevation angle 60 of the sound source 703 to a particular setting of the feedback system 809. As described above, the feedback system 809, whether it is an acoustic feedback system, visual feedback system, or haptic feedback system may indicate the location of the sound source 703 via acoustic, visual, or haptic feedback, which feedback may be defined, at least in part, based on the azimuth angle 50 and the elevation angle 60 of the sound source 703.

As a specific example, the feedback system 809 may indicate a location of the sound source 703 relative to a center point of the transparent display surface 705. This may include activating those feedback devices that correspond to the azimuth and elevation location of the sound source 703. For example, as depicted in FIG. 7A, the transparent display surface 705 may be divided into quadrants. In that figure, the sound source 703 is located in the upper-right quadrant. Accordingly, in this example, feedback devices located on the top of the frame 701 and the right side of the frame 701 may be activated. Activating these specific location-specific feedback components may provide a cue to the wearer as to the location of the sound source 703. That is, the instruction module 522 may include machine-readable instructions that cause the processor 510 to 1) activate a feedback device from a vertical pair of feedback devices based on the elevation angle 60 of the sound source 703 and 2) activate a feedback device from a horizontal pair of feedback devices based on the azimuth angle 50 of the sound source 703.

Accordingly, the mapping(s) 534 may include a mapping between the azimuth angle 50 and the elevation angle 60 of the sound source 703 and respective feedback components of the feedback system 809 that should be activated. In some examples, the indication of which feedback component to activate may be based on the sign of the azimuth angle 50 and the elevation angle 60. For example, for a positive elevation angle 60, a top feedback component may be activated, while for a negative elevation angle 60, a bottom feedback component may be activated. Similarly, for a positive azimuth angle 50, a right feedback component may be activated, while for a negative azimuth angle 50, a left feedback component may be activated.

Still further in this example, the mapping(s) 534 may include a mapping between feedback intensity and the azimuth angle 50 and the elevation angle 60. For example, a more intense feedback (e.g., louder sound, stronger vibration, brighter light) may be used when the sound source 703 is closer to the center of the transparent display surface 705. Accordingly, when the azimuth angle 50 and the elevation angle 60 are closer to a centroid (i.e., a calibrated 0° azimuth angle 50 and a 0° elevation angle 60), the feedback intensity may be at a maximum. By comparison, when the azimuth angle 50 and the elevation angle 60 are near a periphery of the transparent display surface 705, the feedback intensity may be at a minimum. In this example, the system may guide the user gaze toward the sound source 703. For example, the user may adjust their gaze/head position based on the intensity of the feedback and may centralize the sound source 703 within their field of view when the feedback intensity is at a maximum value.

In either of these examples, the mapping(s) 534 may also include a transformation matrix that converts the azimuth angle 50 and the elevation angle 60, which may be calculated relative to a center point of the transducer array (e.g., the camera sensor 210 of the acoustic camera 200) to a frame of reference for the transparent display surface 705. Such a transformation matrix may be based on calibration data that indicates the spatial relationship between the array of transducers and the center of the transparent display surface 705. In this example, the instruction module 522 may include instructions that cause the processor 510 to shift the azimuth angle 50 and the elevation angle 60 from a perspective of the sound localization system and/or acoustic camera 200 to the perspective of the transparent display surface 705. This may include translating the coordinate system of the sound localization system and/or the acoustic camera 200 to that of the transparent display surface 705.

Still further, in some examples, the mapping(s) 534 may include a mapping between the azimuth angle 50, the elevation angle 60, from the perspective of the transparent display surface 705, and the control of certain motors within the feedback system 809. For example, as depicted below regarding FIGS. 14 and 15, the feedback system 809 may include a motorized light source that can change the emanation angle of a light beam. In this example, the mapping(s) 534 may include a mapping between the azimuth angle 50, the elevation angle 60, and corresponding motor control commands that will generate a light beam at the intended position. Accordingly, once the azimuth angle 50 and elevation angle 60 are determined, the data acquisition system 500 may acquire the corresponding motor control commands, such as motor position, number of rotations, or rotation angle, and activate the corresponding motors per the mapped values to generate a light beam to project on the transparent display surface 705 at the intended location.

As described above, the instruction module 522 contains machine-readable instructions that cause the processor(s) 510 to perform any of the methodologies described herein, such as those depicted in the methods 700 and 1000. In one particular example, the instruction module 522 includes machine-readable instructions that cause the processor 510 to vary the intensity of the feedback based on the distance between the location of the sound source 703 and the center point of the transparent display surface 705. In one specific example, the instruction module 522 may include instructions that cause the processor 510 to increase the intensity of the feedback as the azimuth angle 50 and the elevation angle 60 approach a center point of the transparent display surface 705. By comparison, the instruction module 522 may decrease the intensity of the feedback as the azimuth angle 50 and the elevation angle 60 move away from the center point of the transparent display surface 705. That is to say, as the sound source 703 location more closely aligns with the center point of the transparent display surface 705, the intensity may increase.

Even more specifically, the instruction module 522 may vary an intensity of a vertical pair of feedback devices based on the elevation angle 60, for example, by increasing the intensity of the vertical pair of feedback devices as the elevation angle 60 approaches a center point of the transparent display surface 705 and decreasing the intensity of the vertical pair of feedback devices as the elevation angle 60 moves away from the center point. Similarly, the instruction module 522 may vary an intensity of a horizontal pair of feedback devices based on the azimuth angle 50, for example, by increasing the intensity of the horizontal pair of feedback devices as the azimuth angle 50 approaches a center point of the transparent display surface 705 and decreasing the intensity of the horizontal pair of feedback devices as the azimuth angle 50 moves away from the center point. As such, the system may guide the user to center the sound source 703 in their field of view based on the increased intensity. Accordingly, a user may move their head in a fashion where feedback intensity increases until the feedback intensity reaches a maximum, at which point the sound source 703 should be at the center of their field of view.

In an example where the system indicates a location of the sound source 703, the instruction module 522 may activate specific feedback devices based on the respective azimuth angle 50 or elevation angle 60. For example, the instruction module 522 may activate a feedback device from a vertical pair of feedback devices based on the elevation angle 60 of the sound source 703. For example, when the sound source 703 has a positive elevation angle 60 (i.e., it is above a horizontal centerline of the transparent display surface 705), a top feedback device may be activated. By comparison, when the sound source 703 has a negative elevation angle 60 (i.e., it is below the horizontal centerline of the transparent display surface 705), a bottom feedback device may be activated. Similarly, the instruction module 522 may activate a feedback device from a horizontal pair of feedback devices based on the azimuth angle 50 of the sound source 703. For example, when the sound source 703 has a positive azimuth angle 50 (i.e., it is to the right of a vertical centerline of the transparent display surface 705), a right feedback device may be activated. By comparison, when the sound source 703 has a negative azimuth angle 50 (i.e., it is to the left of a vertical centerline of the transparent display surface 705), a left feedback device may be activated. As described above, the intensity of the feedback may be varied based on the value of the respective azimuth angle 50 or elevation angle 60.

As described above, in each of these examples, the activation of specific feedback devices and the degree to which they are activated may be based on the mapping(s) 534 that map particular azimuth angles 50 and elevation angles 60 to feedback devices, feedback intensity, and/or feedback device controllers (e.g., motors). The instruction module 522, therefore, also includes machine-readable instructions that cause the processor 510 to generate the feedback, whether such feedback is acoustic, haptic, or visual feedback, or an on-surface projection. That is, the instruction module 522 may generate command instructions per the appropriate feedback device to activate the feedback device in accordance with the determined azimuth angle 50, elevation angle 60, and mapping(s) 534.

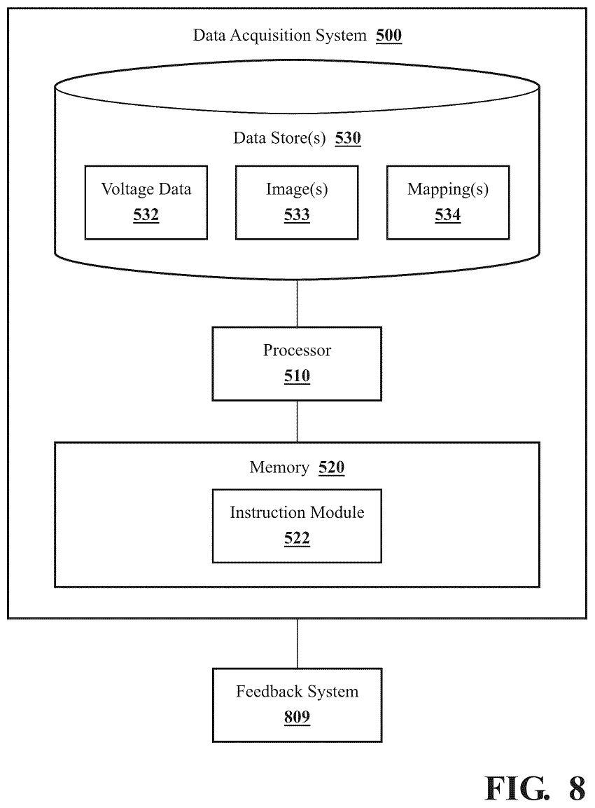

FIGS. 9A and 9B illustrate the frame 701 and various feedback devices 911A-F with the feedback intensity increasing based on the location of the sound source 703. As described above, the system includes various feedback devices 911A, 911B, 911C, 911D, 911E, and 911F. FIGS. 9A-9B depict generic feedback devices, while FIGS. 11-13 depict specific examples of different feedback devices. As depicted in FIGS. 9A and 9B, the feedback intensity may increase as the sound source 703 becomes more central in the field of view of the user, whether due to movement of the sound source 703 or due to movement of the user.

As depicted in FIG. 9A, based on the azimuth angle 50 and the elevation angle 60, the data acquisition system 500 may generate feedback by activating one or more feedback devices 911A-F. In the example depicted in FIGS. 9A and 9B, each feedback device 911A-F may be activated as indicated by the curved lines emanating from each feedback device 911A-F. In other examples, such as those described above, a subset of feedback devices may be activated, the subset pertaining to the region of the field of view where the sound source 703 is located.

In either case, the intensity of the feedback may be based on the distance between the sound source 703 and the center of the transparent display surface 705. That is, the transparent display surface 705 may have a center point, which may be defined in part by the forward view of the user. This center point may be calibrated as having a 0° elevation angle 60 and a 0° azimuth angle 50. Accordingly, as the sound source 703 approaches this center point (as defined by determining the azimuth angle 50 and elevation angle 60 relative to the sound localization system or acoustic camera 200 center point transformed via a mapping 534), the intensity of the feedback may be increased as depicted in FIG. 9B via the increased curved lines emanating from each feedback device 911A-F.

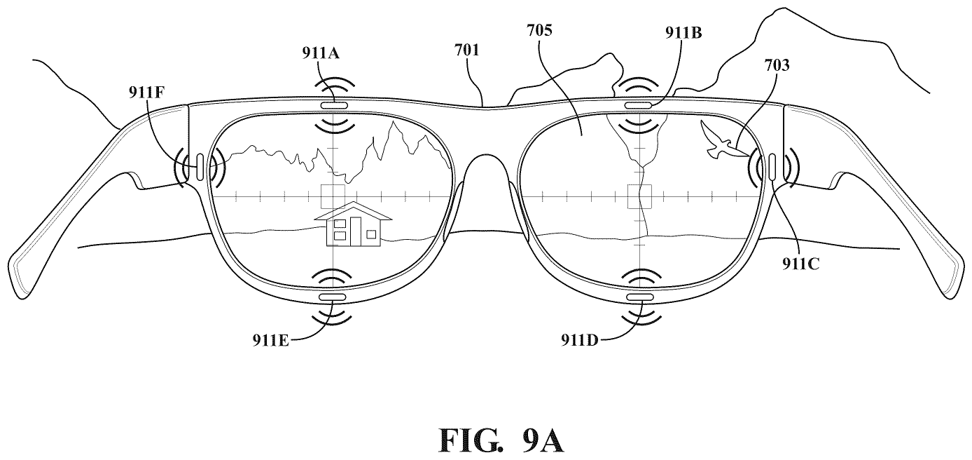

FIG. 10 illustrates a flowchart for one embodiment of a method 1000 that is associated with identifying and indicating a sound source 703 location. The method 1000 will be described from the viewpoint of the data acquisition system 500 in FIG. 8. However, it should be understood that this is just one example of implementing the method 1000. While the method 1000 is discussed in combination with the data acquisition system 500, it should be appreciated that the method 1000 is not limited to being implemented within the data acquisition system 500 but is instead one example of a system that may implement the method 1000. As such, the method 1000 may be embodied within the instruction module 522 as processor-executable and machine-readable instructions that, when executed by the processor(s) 510, cause the processor(s) 510 to perform the method 1000.

As described above, in general, the data acquisition system 500 may determine, via a sound localization system formed on a frame 701 to be worn on the head of a user, an azimuth angle 50 and an elevation angle 60 of a sound source 703.

More specifically, at 1010, the instruction module 522 includes machine-readable instructions that, when executed by the processor(s) 510, cause the processor(s) 510 to receive a first voltage (V_{1A}) and a second voltage (V_{2A}) from the capacitively coupled circuit 400A. Alternatively, instead of receiving the first voltage (V_{1A}) and the second voltage (V_{2A}) directly from the capacitively coupled circuit 400A, the first voltage (V_{1A}) and the second voltage (V_{2A}) may have been previously stored in the data store(s) 530 as the voltage data 532.

In one specific example, the instruction module 522 also includes machine-readable instructions that, when executed by the processor(s) 510, cause the processor(s) 510 to capture an image using the camera sensor 210 of the acoustic camera 200. The image may be stored within the data acquisition system 500 as the image(s) 533.

As mentioned before, the first voltage (V_{1A}) may be the voltage across the inductor 416A of the first circuit 410A, while the second voltage (V_{2A}) may be the voltage across the inductor 436A of the second circuit 430A. Generally, the first voltage (V_{1A}) and the second voltage (V_{2A}) may be corresponding pairs of voltages measured at or near the same time as the image was captured. As such, the first voltage (V_{1A}) and the second voltage (V_{2A}) are the voltages generated by the capacitively coupled circuit 400A when the acoustic wave from the sound source 703 is sensed by the transducers 220A and 220B. As mentioned before, the first voltage (V_{1A}) and the second voltage (V_{2A}) may be stored as pairs as the voltage data 532 in the data store(s) 530.

In step 1020, the instruction module 522 includes instructions that, when executed by the processor(s) 510, cause the processor(s) 510 to determine a first ratio between the first voltage (V_{1A}) and the second voltage (V_{2A}). Which first voltage (V_{1A}) may be from a first circuit 410A coupled to a first transducer of a vertical pair of transducers, and which second voltage (V_{2A}) may be from a second circuit 430A coupled to a second transducer of the vertical pair. In one example, this may be determined by simply dividing the first voltage (V_{1A}) by the second voltage (V_{2A}) or vice versa.

In step 1030, the instruction module 522 includes instructions that, when executed by the processor(s) 510, cause the processor(s) 510 to determine the elevation angle 60 based on the first ratio between the first voltage (V_{1A}) and the second voltage (V_{2A}). In one example, as mentioned before, the mapping(s) 534 may be a reference table or lookup table that can be used to reference a particular ratio to the elevation angle 60 of the sound source 703 with respect to the centroid of the transducer array (e.g., the centroid of the camera sensor 210 of the acoustic camera 200).

In step 1040, the instruction module 522 includes machine-readable instructions that, when executed by the processor(s) 510, cause the processor(s) 510 to receive a third voltage (V_{1B}) and a fourth voltage (V_{2B}) from the capacitively coupled circuit 400B. Alternatively, instead of receiving the third voltage (V_{1B}) and the fourth voltage (V_{2B}) directly from the capacitively coupled circuit 400B, the third voltage (V_{1B}) and the fourth voltage (V_{2B}) may have been previously stored in the data store(s) 530 as the voltage data 532.

As mentioned before, the third voltage (V_{1B}) may be the voltage across the inductor 416B of the first circuit 410B, while the fourth voltage (V_{2B}) may be the voltage across the inductor 436B of the second circuit 430B. Generally, the third voltage (V_{1B}) and the fourth voltage (V_{2B}) may be corresponding pairs of voltages measured at or near the same time as the image was captured. As such, the third voltage (V_{1B}) and the fourth voltage (V_{2B}) are the voltages generated by the capacitively coupled circuit 400B when the acoustic wave from the sound source 703 is sensed by the transducers 220C and 220D. As mentioned before, the third voltage (V_{1B}) and the fourth voltage (V_{2B}) may be stored as pairs as the voltage data 532 in the data store(s) 530.

In step 1050, the instruction module 522 includes instructions that, when executed by the processor(s) 510, cause the processor(s) 510 to determine a second ratio between the third voltage (V_{1B}) and the fourth voltage (V_{2B}). Which third voltage (V_{1B}) may be from a first circuit 410B coupled to a first transducer of a horizontal pair of transducers, and which fourth voltage (V_{2B}) may be from a second circuit 430B coupled to a second transducer of the horizontal pair. In one example, this may be determined by simply dividing the third voltage (V_{1B}) by the fourth voltage (V_{2B}) or vice versa.

In step 1060, the instruction module 522 includes instructions that, when executed by the processor(s) 510, cause the processor(s) 510 to determine the azimuth angle 50 based on the second ratio between the third voltage (V_{1B}) and the fourth voltage (V_{2B}). In one example, as mentioned before, the mapping(s) 534 may be a reference table or lookup table that can be used to reference a particular ratio to the azimuth angle 50 of the sound source 703 with respect to the centroid of the transducer array (e.g., the centroid of the camera sensor 210 of the acoustic camera 200).

In this example, the method 1000 first determined the elevation angle 60 (steps 1010-1030) before determining the azimuth angle 50 (steps 1040-1060). However, it should be understood that the method 1000 may determine the azimuth angle 50 before determining the elevation angle 60. Further still, it may be possible that the method 1000 may be able to determine the azimuth angle 50 and the elevation angle 60 concurrently.

In step 1070, the instruction module 522 includes machine-readable instructions that, when executed by the processor(s) 510, cause the processor(s) 510 to generate, via the feedback system 809, feedback to indicate a location of the sound source 703 relative to a center point of a transparent display surface 705 of the frame 701. This is accomplished by utilizing the azimuth angle 50 and the elevation angle 60, which generally indicates the direction of the sound source 20 that produces the acoustic wave and activates various feedback devices 911A-F based on the determined azimuth angle 50 and elevation angle 60 as described above. As described above, generating the surface-oriented feedback may include converting the azimuth angle 50 and the elevation angle 60 from a frame of reference of the sound localization system/acoustic camera to the frame of reference of the transparent display surface 705. As described above, this may be done via the transformation matrix that may be stored as mapping 534 data within the data store 530. As such, the intensity and subset of feedback devices 911A-F that have been activated may indicate to the wearer where the sound source 703 is located within their field of view and/or guide the gaze of the user to centralize the sound source 703 within their field of view.

As described above, the feedback system 809 may take various forms. FIGS. 11-13 depict various example feedback systems 809. Specifically, FIG. 11 illustrates the frame 701 with an acoustic feedback system for identifying and indicating the location of a sound source 703. In this example, the feedback system includes acoustic speakers 1113A-F integrated into the frame 701. As depicted, the acoustic speakers 1113A-F may be spaced around the frame 701 in such a fashion that a directional location of the sound source 703 may be indicated by such. For example, some of the acoustic speakers 1113A and 1113B may be used to indicate when the sound source elevation angle 60 has a positive value, other acoustic speakers 1113D and 1113E may be used to indicate when the sound source elevation angle 60 has a negative value, another acoustic speaker 1113C may be used to indicate when the sound source azimuth angle 50 has a positive value, and another acoustic speaker 1113F may be used to indicate when the sound source azimuth angle 50 has a negative value. Accordingly, as described above, different acoustic speakers 1113A-F may be activated based on the azimuth angle 50 of the sound source 703, the elevation angle 60 of the sound source 703, and the mapping 534 between azimuth and elevation angles and acoustic speakers 1113A-F to be activated.

As described above, in some examples, the volume of some or all of the acoustic speakers 1113A-F may be adjusted based on the location of the sound source (i.e., the sound source azimuth angle and elevation angle) and/or the distance between the sound source 703 and a reference location (e.g., the center) of the transparent display surface 705. For example, the volume may be increased as the sound source azimuth angle 50 and elevation angle 60 approach the center of the transparent display surface 705. In an example, the volume of the speaker 1113A-F output may be represented by the following expression.

$$V = {nV}_{0}^{( - \frac{{θ}^{2} + {ϕ}^{2}}{{σ}^{2}} )} f ( t )$$

In this expression, Vindicates the output volume of the acoustic speakers 1113A-F, n is an amplification variable, V_{θ} is the original sound volume, θ is the azimuth angle, φ is the elevation angle, and f(t) is the normalized real-time audio signal. Also in this expression, σ represents a volume change as a function of a Gaussian distribution. That is, σ may indicate the rate of change of the volume signal based on the azimuth angle 50 and the elevation angle 60.

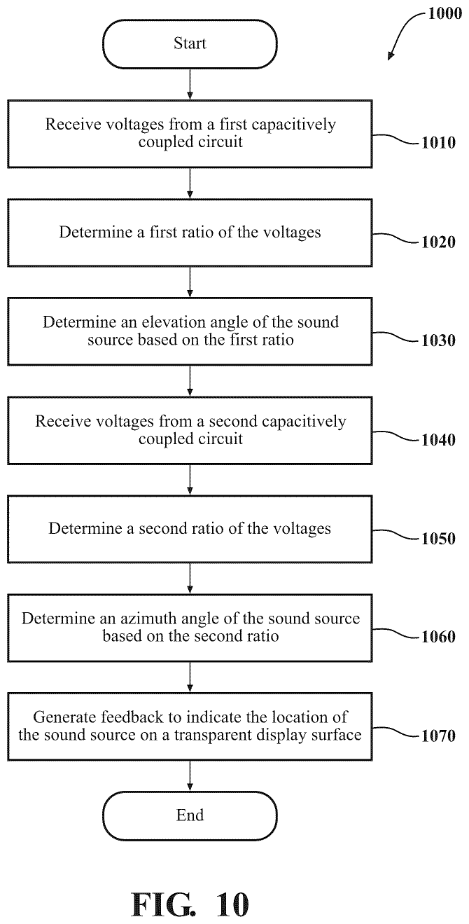

FIG. 12 illustrates the frame 701 with a haptic feedback system for identifying and indicating the location of a sound source 703. In this example, the feedback system includes haptic feedback devices 1215A-F integrated into the frame 701. As depicted, the haptic feedback devices 1215A-F may be spaced around the frame 701 in such a fashion that a directional location of the sound source 703 may be indicated by such. For example, some of the haptic feedback devices 1215A and 1215B may be used to indicate when the sound source elevation angle 60 has a positive value, other haptic feedback devices 1215D and 1215E may be used to indicate when the sound source elevation angle 60 has a negative value, another haptic feedback device 1215C may be used to indicate when the sound source azimuth angle 50 has a positive value, and another haptic feedback device 1215F may be used to indicate when the sound source azimuth angle 50 has a negative value. Accordingly, as described above, different haptic feedback devices 1215A-F may be activated based on the azimuth angle 50 of the sound source 703, the elevation angle 60 of the sound source 703, and the mapping 534 between azimuth and elevation angles and haptic feedback devices 1215A-F to be activated.

As described above, in some examples, the vibrational energy of some or all of the haptic feedback devices 1215A-F may be adjusted based on the location of the sound source (i.e., the sound source azimuth angle and elevation angle) and/or the distance between the sound source 703 and a reference location (e.g., the center) of the transparent display surface 705. For example, the vibrational energy may be increased as the sound source azimuth angle 50 and elevation angle 60 approach the center of the transparent display surface 705. In an example, the vibrational energy of the haptic feedback devices 1215A-F output may be represented by the following expression.

$$S = {S}_{0}^{( - \frac{{θ}^{2} + {ϕ}^{2}}{{σ}^{2}} )}$$

In this expression, S indicates the output vibration of the haptic feedback devices 1215A-F, S₀ is a maximum vibrational energy, θ is the azimuth angle, and φ is the elevation angle. Also in this expression, σ represents a vibration change as a function of a Gaussian distribution. That is, σ may indicate the rate of change of the vibration signal based on the azimuth angle 50 and the elevation angle 60.

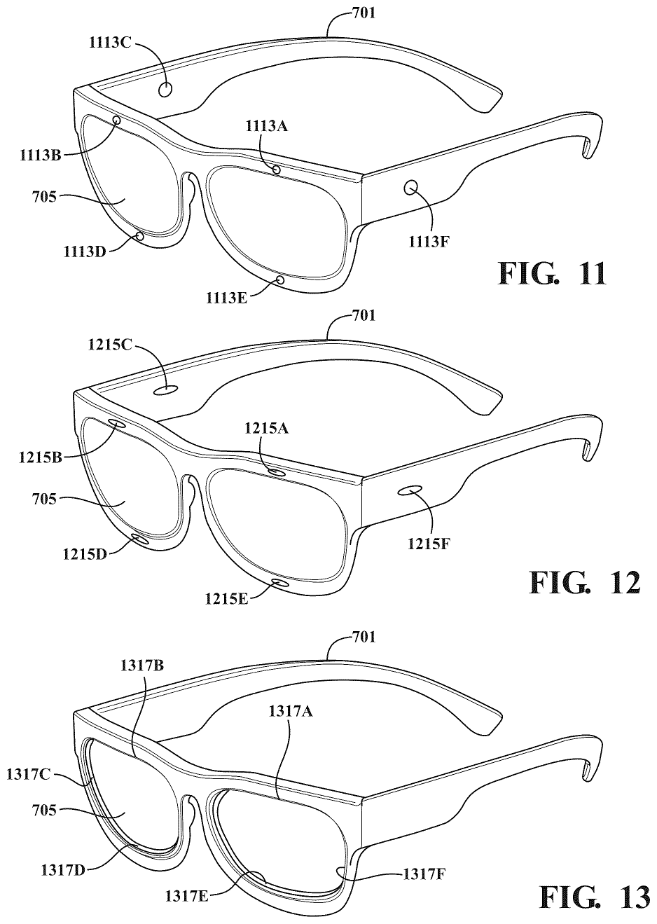

FIG. 13 illustrates the frame 701 with a visual feedback system for identifying and indicating the location of a sound source 703. In this example, the feedback system includes light elements 1317A-F integrated into the frame 701. In an example, the light element may include one or more strips of LED elements. As described above, the lighting elements 1317A-F may be spaced around the frame 701 in such a fashion that a directional location of the sound source 703 may be indicated by such. For example, some of the lighting elements 1317A and 1317B may be used to indicate when the sound source elevation angle 60 has a positive value, other lighting elements 1317D and 1317E may be used to indicate when the sound source elevation angle 60 has a negative value, another lighting element 1317C may be used to indicate when the sound source azimuth angle 50 has a positive value, and another lighting element 1317F may be used to indicate when the sound source azimuth angle 50 has a negative value. Accordingly, as described above, different lighting elements 1317A-F may be activated based on the azimuth angle 50 of the sound source, the elevation angle 60 of the sound source, and the mapping 534 between azimuth and elevation angles and lighting elements 1317A-F to be activated.

As described above, in some examples, the brightness of some or all of the lighting elements 1317A-F may be adjusted based on the location of the sound source (i.e., the sound source azimuth angle and elevation angle) and/or the distance between the sound source 703 and a reference location (e.g., the center) of the transparent display surface 705. For example, the brightness may be increased as the sound source azimuth angle 50 and elevation angle 60 approach the center of the transparent display surface 705. In an example, the brightness of the lighting elements 1317A-F output may be represented by the following expression.

$$B = {B}_{0}^{( - \frac{{θ}^{2} + {ϕ}^{2}}{{σ}^{2}} )}$$

In this expression, B indicates the output brightness of the lighting elements 1317A-F, B₀ is a maximum brightness, θ is the azimuth angle, and φ is the elevation angle. Also in this expression, σ represents a vibration change as a function of a Gaussian distribution. That is, σ may indicate the rate of change of the brightness based on the azimuth angle 50 and the elevation angle 60.

FIG. 14 illustrates a frame 701 with a first type of projection system 1421 for identifying and indicating the location of a sound source 703. That is, in this example, the feedback system 809 is a projection system 1421 that emanates a visible light beam 1419 toward a location on the transparent display surface 705 that maps to the location of the sound source 703. As described above, this may be based on a mapping 534, which maps the azimuth angle 50 and the elevation angle 60 of the sound source 703 to motor controls. Specifically, the mapping 534 may indicate a motor position/state for given azimuth angles 50 and elevation angles 60 of the sound source 703. The mapped motor controls position a light source 1423 such that the emanated light beam 1419 hits the transparent display surface 705 at the location of the sound source 703. This mapping 534 may be specific to the display system and may be calibrated during manufacturing or assembly and recalibrated as needed.

Specifically in this example, the projection system 1421 includes a light source 1423, such as a low-intensity laser, LED, or any other light source 1423 that may emit a light beam 1419. The projection system 1421 may also include an azimuth motor 1425 that controls the azimuth position of the light beam 1419 emanating from the light source 1423. For example, the azimuth motor 1425 may be a servo motor or stepper motor that can linearly move the light source 1423 horizontally or can rotate the light source 1423 horizontally (e.g., pan the light source 1423).

The projection system 1421 may also include an elevation motor 1427 that controls the elevation position of the light beam 1419 emanating from the light source 1423. For example, the elevation motor 1427 may be a servo motor, stepper motor, or other motor that can move the light source 1423 vertically or can rotate the light source 1423 vertically (e.g., tilt the light source 1423). In either case, as described above, the instruction module 522 may include instructions that cause the processor 510 to control the azimuth motor 1425 and the elevation motor 1427 to project a light beam 1419 onto the transparent display surface 705 based on the azimuth angle 50 and the elevation angle 60 of the sound source 703, which movement is defined by the mapping 534 between the azimuth angle 50, elevation angle 60, and motor controls.

Note that while particular reference is made to motors that move a light source 1423, the projection systems may use other types of systems, for example, a system where a motor moves a mirror or lens to change the position of the light beam 1419.

FIG. 15 illustrates a frame 701 with a second type of projection system 1529 for identifying and indicating the location of a sound source 703. That is, as with FIG. 14, in this example, the feedback system is a projection system 1529, albeit of a different type. As with the example depicted in FIG. 14, in this example, the projection system 1529 includes a light source 1423. In general, the light source 1423 may include an emanating end and a distal end. The emanating end is a portion of the light source 1423 housing from which the light beam 1419 emanates. In this system, the emanating end is disposed within a radial spherical bearing 1531.

In general, a radial spherical bearing 1531 is a bearing that accommodates misalignment between a shaft (i.e., the light source 1423) and a housing. The radial spherical bearing 1531 includes an inner ring with a convex outer surface and an outer ring with a concave inner surface. This arrangement allows the inner ring to pivot within the outer ring. In an example, the outer ring of the radial spherical bearing 1531 may be rigidly mounted to the frame 701, for example, to one of the arms/temples of the frame 701.

The distal end of the light source 1423 may be pivotally affixed to a rotating plate 1533. That is, as described below, due to an interaction of a threaded shaft 1537 and a fixed threaded nut 1535, the rotating plate 1533 may spin about a longitudinal axis. As depicted in FIG. 15, the distal end of the light source 1423 may be affixed to a non-central position of the rotating plate 1533. Accordingly, as the rotating plate 1533 and the distal end of the light source 1423 spin about the longitudinal axis of the rotating plate 1533, the emanating end of the light source 1423 pivots within the radial spherical bearing 1531.

The projection system 1529 also includes a threaded shaft 1537 affixed to the rotating plate 1533 and passing through a fixed threaded nut 1535. A motor 1539 rotates the threaded shaft 1537 within the fixed threaded nut 1535. That is, the motor 1539 may be a servo motor or stepper motor that rotates the threaded shaft 1537. This rotation causes the rotating plate 1533, to which the threaded shaft 1537 is affixed, also to rotate, which, as described above, may cause the emanating end of the light source 1423 to pivot and alter the position of the emanating light beam 1419.

Via 1) the interaction of the threads on the threaded shaft 1537 and the fixed threaded nut 1535, and 2) the fixed nature of the fixed threaded nut 1535, which may be fixed to the frame 701, rotation of the threaded shaft 1537 may also cause the threaded shaft 1537 and the rotating plate 1533 to translate longitudinally. That is to say, the threaded shaft 1537 and the rotating plate 1533 1) rotate about the longitudinal axis and 2) translate along the longitudinal axis. The translation changes the vertical angle of the light source 1423 relative to the radial spherical bearing 1531.

Put another way, the rotation of the threaded shaft 1537 generates a spiral trajectory for the light beam 1419 that emanates from the light source 1423. Accordingly, the light beam 1419 may be made to project onto different locations on the transparent display surface 705 along the spiral trajectory. The light beam 1419 may be specifically projected onto a location of the transparent display surface 705 that corresponds to the location of the sound source 703. That is, the instruction module 522 may include machine-readable instructions that cause the processor 510 to control the motor 1539 to project a light beam 1419 onto the transparent display surface 705 based on the azimuth angle 50 and the elevation angle 60 of the sound source 703. As described above, this may be achieved via the mappings 534, which map motor control (e.g., motor position, motor current, etc.) to azimuth angles 50 and elevation angles 60.

Accordingly, the present system not only precisely identifies the location of a sound source within a field of view of an environment through transparent lenses, but also provides feedback that 1) identifies the location of the sound source and/or 2) guides the gaze of the wearer of the eyeglasses to center on the sound source via increasing the intensity of the feedback as the gaze centers on the sound source.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, modules used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™ Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system, comprising:
a frame, comprising a transparent display surface, to be worn on a head of a user;
a sound localization system disposed on the frame, the sound localization system comprising:
an array of transducers;
a feedback system; and
a capacitively coupled circuit per transducer pair; and
a data acquisition system, the data acquisition system comprising:
a memory comprising machine-readable instructions that, when executed by a processor, cause the processor to:
determine an azimuth angle and an elevation angle of a sound source; and
generate, via the feedback system, feedback to indicate a location of the sound source relative to a center point of the transparent display surface.

2. The system of claim 1:
further comprising a camera sensor disposed on the frame; and
wherein the transducers of the array are adjacent to and surrounding the camera sensor.

3. The system of claim 2, wherein:
the transducers are equally spaced apart from one another along a perimeter that surrounds the camera sensor;
transducers of a first pair of transducers are 180 degrees away from each other around the perimeter; and
transducers of a second pair of transducers are 180 degrees away from each other around the perimeter.

4. The system of claim 1, wherein the memory further comprises a machine-readable instruction that, when executed by the processor, causes the processor to vary an intensity of the feedback based on a distance between the location of the sound source and the center point of the transparent display surface.

5. The system of claim 4, wherein the machine-readable instruction to vary the intensity of the feedback comprises machine-readable instructions that cause the processor to:
vary an intensity of a vertical pair of feedback devices based on the elevation angle; and
vary an intensity of a horizontal pair of feedback devices based on the azimuth angle.

6. The system of claim 4, wherein the machine-readable instruction to vary the intensity of the feedback comprises machine-readable instructions that cause the processor to:
increase an intensity of the feedback as the azimuth angle and the elevation angle approach the center point of the transparent display surface; and
decrease an intensity of the feedback as the azimuth angle and the elevation angle move away from the center point of the transparent display surface.

7. The system of claim 1, wherein the machine-readable instruction to generate the feedback comprises machine-readable instructions that, when executed by the processor, cause the processor to:
activate a feedback device from a vertical pair of feedback devices based on the elevation angle of the sound source; and
activate a feedback device from a horizontal pair of feedback devices based on the azimuth angle of the sound source.

8. The system of claim 1, wherein the feedback system comprises at least one of:
acoustic speakers integrated into the frame;
haptic feedback devices integrated into the frame; or
lighting elements integrated into the frame.

9. The system of claim 1, wherein:
the feedback system comprises a projection system, the projection system comprising:
a light source;
an azimuth motor to control an azimuth position of a light beam from the light source; and
an elevation motor to control an elevation position of the light beam; and
the machine-readable instruction to generate the feedback comprises machine-readable instructions that, when executed by the processor, cause the processor to control the azimuth motor and elevation motor to project the light beam onto the transparent display surface based on the azimuth angle and the elevation angle.

10. The system of claim 1, wherein:
the feedback system comprises a projection system, the projection system comprising:
a light source comprising:
an emanating end disposed within a radial spherical bearing; and
a distal end pivotally mounted to a rotating plate;
a threaded shaft affixed to the rotating plate;
a fixed threaded nut; and
a motor to rotate the threaded shaft within the fixed threaded nut, rotation of the threaded shaft:
translates the threaded shaft and rotating plate; and
generates a spiral trajectory for a light beam from the light source; and
the machine-readable instruction to generate the feedback comprises machine-readable instructions that, when executed by the processor, cause the processor to control the motor to project a light beam from the light source onto the transparent display surface based on the azimuth angle and the elevation angle.

11. The system of claim 1, wherein the machine-readable instruction to determine the azimuth angle and the elevation angle of the sound source comprises machine-readable instructions to:
determine a first ratio between a first voltage, from a first circuit coupled to a first transducer of a vertical pair of transducers, and a second voltage, from a second circuit coupled to a second transducer of the vertical pair;
identify the elevation angle based on the first ratio;
determine a second ratio between a third voltage, from a first circuit coupled to a first transducer of a horizontal pair of transducers, and a fourth voltage, from a first circuit coupled to a second transducer of the horizontal pair; and
identify the azimuth angle based on the second ratio.

12. A non-transitory machine-readable medium comprising instructions that, when executed by a processor, cause the processor to:
determine, via a sound localization system disposed on a frame to be worn on a head of a user, an azimuth angle and an elevation angle of a sound source, the sound localization system comprises:
an array of transducers;
a feedback system; and
a capacitively coupled circuit per transducer pair; and
generate, via the feedback system, feedback to indicate a location of the sound source relative to a center point of a transparent display surface of the frame.

13. The non-transitory machine-readable medium of claim 12, wherein the medium further comprises an instruction that, when executed by the processor, causes the processor to vary an intensity of the feedback based on a distance between the location of the sound source and the center point of the transparent display surface.

14. The non-transitory machine-readable medium of claim 13, wherein the instruction to vary the intensity of the feedback comprises instructions that cause the processor to:
vary an intensity of a vertical pair of feedback devices based on the elevation angle; and
vary an intensity of a horizontal pair of feedback devices based on the azimuth angle.

15. The non-transitory machine-readable medium of claim 12, wherein the instruction to generate the feedback comprises instructions that, when executed by the processor, cause the processor to:
activate a feedback device from a vertical pair of feedback devices based on the elevation angle of the sound source; and
activate a feedback device from a horizontal pair of feedback devices based on the azimuth angle of the sound source.

16. A method, comprising:
determining, via a sound localization system disposed on a frame to be worn on a head of a user, an azimuth angle and an elevation angle of a sound source, the sound localization system comprises:
an array of transducers;
a feedback system; and
a capacitively coupled circuit per transducer pair; and
generating, via the feedback system, feedback to indicate a location of the sound source relative to a center point of a transparent display surface of the frame.

17. The method of claim 16, further comprising varying an intensity of the feedback based on a distance between the location of the sound source and the center point of the transparent display surface.

18. The method of claim 17, wherein varying the intensity of the feedback comprises:
varying an intensity of a vertical pair of feedback devices based on the elevation angle; and
varying an intensity of a horizontal pair of feedback devices based on the azimuth angle.

19. The method of claim 16, wherein generating the feedback comprises:
activating a feedback device from a vertical pair of feedback devices based on the elevation angle of the sound source; and
activating a feedback device from a horizontal pair of feedback devices based on the azimuth angle of the sound source.

20. The method of claim 16, wherein generating the feedback comprises at least one of:
generating acoustic feedback through acoustic speakers integrated into the frame;
generating haptic feedback through haptic feedback devices integrated into the frame;
generating visual feedback through lighting elements integrated into the frame; or
projecting a light beam onto the transparent display surface.
